(19) United States
(12) Patent Application Publication
(10) Pub. No.: US 2025/0369617 A1
(43) Pub. Date: Dec. 4, 2025

(54) Integrated Gas Stove

(71) Applicant: ZHONGSHAN JINWEN ELECTRICAL APPLIANCE INDUSTRIAL CO., LTD., Zhongshan (CN)

(72) Inventors: Chunxiu Zou, Zhongshan (CN); Jingwen Deng, Zhongshan (CN); Jinfei Li, Zhongshan (CN); Wang Zhu, Zhongshan (CN)

(21) Appl. No.: 18/782,300

(22) Filed: Jul. 24, 2024

(30) Foreign Application Priority Data
May 29, 2024 (CN) 202410675652.9

(51) Int. Cl. F24C 3/12; F24C 15/20

(52) U.S. Cl. CPC F24C 3/128; F24C 15/2007

(57) ABSTRACT

An integrated gas stove includes a rack, a cooker assembly, an oven assembly and a fume exhaust pipe. The cooker assembly arranged at an upper part of the rack includes a burner assembly. The oven assembly on the rack is positioned below the cooker assembly. The oven assembly includes a case body in the rack and a combustion assembly below the case body. The case body has an exhaust hole on an upper part and a heat conduction hole on a lower part, so that hot air generated by combustion in the combustion assembly enters the case body through the heat conduction hole. A fume inlet of a fume exhaust pipe is connected to the exhaust hole, and a fume outlet of the fume exhaust pipe arranged above the cooker assembly obliquely faces downwards the burner assembly. The fume exhaust pipe tapers from the fume inlet to the fume outlet.

### CROSS-REFERENCE TO RELATED APPLICATION

This application claims priority to Chinese Patent Application No. 202410675652.9 filed May 29, 2024, the disclosure of which is hereby incorporated by reference in its entirety.

### BACKGROUND

### Technical Field

The present disclosure relates to a gas equipment, in particular to an integrated gas stove.

### Technical Considerations

An integrated gas stove is generally integrated with an oven, a cooker and a range hood, and the range hood which is able to satisfy a function of extracting and discharging oil fume from the oven and the cooker. In order to adapt to the integrated gas stove that has preinstalled the range hood already or the integrated gas stove that needs to be moved, in related technology, there are some integrated gas stoves only including the oven and the cooker. In other words, the gas equipment is retained in the integrated gas stove, but the electrically driven range hood is separated from the integrated gas stove. When such an integrated gas stove is used indoors, a range hood previously installed indoors is required to extract and discharge the oil fume. However, in related technology, the range hood installed indoors is generally arranged according to the cooker, without considering problems of the oil fume exhaust of the oven, and the oven is not arranged with pipes connected to the domestic range hood. Therefore, it is easy to cause oil fume from the oven to remain indoors, affecting the use of the integrated gas stove.

### SUMMARY

The present disclosure is directed to solving at least one of the problems of the related technology. Therefore, the present disclosure provides an integrated gas stove which can better solve the problem of oil fume exhaust of an oven in the integrated gas stove.

The integrated gas stove according to a first non-limiting aspect of embodiments of the present disclosure includes a rack, a cooker assembly, an oven assembly and a fume exhaust pipe. The cooker assembly is arranged at an upper part of the rack and includes at least one burner assembly. The oven assembly is arranged on the rack and positioned below the cooker assembly. The oven assembly includes a case body arranged on the rack and a combustion assembly arranged below the case body. An exhaust hole is formed in an upper part of the case body, at least one heat conduction hole is formed on a lower part of the case body, and hot air formed by combustion of the combustion assembly is capable of entering the case body through the heat conduction hole. A fume inlet of the fume exhaust pipe is connected to the exhaust hole, and a fume outlet of the fume exhaust pipe is arranged above the cooker assembly. The fume outlet obliquely faces downwards towards the burner assembly, and a cross-sectional area of the fume exhaust pipe gradually decreases from the fume inlet to the fume outlet.

The integrated gas stove provided by the embodiments of the present disclosure at least has the following beneficial effects. When the integrated gas stove is used, the hot air formed by the combustion of the combustion assembly enters the case body through the heat conduction hole, and food in the case body is heated by the hot air, and oil fume is formed. The oil fume enters the fume exhaust pipe through the exhaust hole, and is conveyed above the cooker assembly through the fume exhaust pipe. The exhaust hole and the heat conduction hole adopt an up and down layout structure, and air convection inside and outside the box can be formed by a chimney effect, so that the fume can be exhausted efficiently. The cross-sectional area of the fume exhaust pipe gradually decreases from the fume inlet to the fume outlet, which can improve an eject velocity of the oil fume at the fume outlet. Since the fume outlet obliquely faces downwards towards the burner assembly, the oil fume that has a certain velocity can efficiently eject to a position that corresponds with the burner assembly, which makes it convenient for external range hood to extract and discharge the oil fume.

According to some non-limiting embodiments of the present disclosure, the fume exhaust pipe includes an ascending section extending from bottom to top and a eject section connecting the ascending section and extending laterally. The fume inlet is disposed at a lower end of the ascending section, and the fume outlet is arranged at a top end of the eject section. The eject section inclines obliquely downward, and an included angle a is formed between the eject section and a cooker plane of the cooker assembly.

According to some non-limiting embodiments of the present disclosure, the included angle a is 5° to 25°.

According to some non-limiting embodiments of the present disclosure, a sum of cross-sectional areas of all the heat conduction holes is larger than a sectional area of the exhaust hole.

According to some non-limiting embodiments of the present disclosure, the combustion assembly includes a burner pipe and a heat conducting plate. The burner pipe has a long tubular structure, and two sides of the burner pipe are respectively provided with a plurality of burner holes. The heat conducting plate is a long plate with a V-shaped cross section. The burner pipe is located below the heat conducting plate and is arranged corresponding to a tip of the V-shaped structure. The burner holes at two sides of the burner pipe correspond to two wings of the V-shaped structure of the heat conducting plate. The heat conduction hole of the case body corresponds to ends of the two wings of the V-shaped structure of the heat conducting plate.

According to some non-limiting embodiments of the present disclosure, the exhaust hole is formed as an elongated hole, and a length direction of the burner pipe and a length extending direction of the exhaust hole are staggered with each other.

According to some non-limiting embodiments of the present disclosure, the exhaust hole is formed as an elongated hole, and a length direction of the burner pipe is perpendicular to a length extending direction of the exhaust hole.

According to some non-limiting embodiments of the present disclosure, each of the ends of the two wings of the heat conducting plate is respectively provided with a flow guiding portion bent obliquely downwards.

According to some non-limiting embodiments of the present disclosure, an outer hole wall of the heat conduction hole is a slope structure inclined outwards from bottom to top.

According to some non-limiting embodiments of the present disclosure, a side wall of the case body is provided with a convex portion which protrudes towards an inside of the case body, and a lower side of the convex portion is a slope structure.

According to some non-limiting embodiments of the present disclosure, the heat conduction hole and the exhaust hole are both elongated holes, and a length extending direction of the heat conduction hole and a length extending direction of the exhaust hole are staggered with each other.

According to some non-limiting embodiments of the present disclosure, a length extending direction of the heat conduction hole and a length extending direction of the exhaust hole are perpendicular to each other.

According to some non-limiting embodiments of the present disclosure, the fume outlet is provided with a switch mechanism capable of controlling an opening degree of the fume outlet.

According to some non-limiting embodiments of the present disclosure, the case body is provided with a temperature detection module, which can detect a temperature T in the case body. The integrated gas stove further includes a control system, which is respectively connected to the temperature detection module and the switch mechanism. The control system can control an action of the switch mechanism according to the temperature T, and the opening degree of the fume outlet is in direct proportion to the temperature T.

According to some non-limiting embodiments of the present disclosure, the opening degree of the fume outlet is D. D is 0 to 100%. The sum of the cross-sectional areas of all the heat conduction holes is S1. The cross-sectional area of the exhaust hole is S2. The opening degree of the fume outlet is calculated by a formula of

$$D = \frac{S 1}{S 2} T K 1 ,$$

where K1 is a correction coefficient.

According to some non-limiting embodiments of the present disclosure, the fume outlet is directed toward a center of the cooker assembly, and a central velocity of the fume sent through the fume outlet when blown to the center of the cooker assembly is V. V is greater than 0 m/s.

According to some non-limiting embodiments of the present disclosure, V is equal to or greater than 0.005 m/s and is equal to or less than 0.02 m/s.

According to some non-limiting embodiments of the present disclosure, in response to the oven assembly being working, an initial velocity of oil fume at the fume outlet is set to be V0, the opening degree of the fume outlet is set to be D, and D is 0 to 100%. The integrated gas stove further includes the control system, which can control the action of the switch mechanism according to the central velocity V. A wind velocity detection unit which is capable of detecting the initial velocity V0 is arranged at the fume outlet. A distance from a central position of the fume outlet to the center of the cooker assembly is set to be L, a wind velocity attenuation coefficient of a unit distance of the fume in air is set to be A, and V=V0−L•A. The control system can calculate the central velocity V by detecting the initial velocity V0, and control the switch mechanism according to a numerical range of the central velocity V, thereby controlling the opening degree D of the fume outlet.

### BRIEF DESCRIPTION OF THE DRAWINGS

The above and/or additional non-limiting aspects and advantages of the present disclosure will become apparent and readily appreciated from the following description of the non-limiting embodiments in conjunction with the accompanying drawings, in which:

FIG. 1 is a schematic structural view of an integrated gas stove according to a non-limiting embodiment of the present disclosure;

FIG. 2 is a schematic structural view of the integrated gas stove according to the embodiment of the present disclosure when a door of the integrated gas stove is opened;

FIG. 3 is a schematic structural view of an internal structure of the integrated gas stove according to the embodiment of the present disclosure;

FIG. 4 is a schematic exploded view of the integrated gas stove according to the embodiment of the present disclosure;

FIG. 5 is a top view of the internal structure of the integrated gas stove according to the embodiment of the present disclosure;

FIG. 6 is a schematic cross-sectional view along A-A of FIG. 5;

FIG. 7 is a schematic cross-sectional view along B-B of FIG. 5;

FIG. 8 is a schematic structural view of a fume exhaust pipe according to the embodiment of the present disclosure; and

FIG. 9 is an exploded view of the fume exhaust pipe according to the embodiment of the present disclosure.

### DETAILED DESCRIPTION

Reference will now be made in detail to embodiments of the present disclosure, examples of which are illustrated in the accompanying drawings, where like reference numerals refer to the same or similar elements or elements having the same or similar functions throughout. The embodiments described below with reference to the accompanying drawings are illustrative only for the purpose of explaining the present disclosure and are not to be construed as limiting the present disclosure.

In the description of the present disclosure, it should be understood that the orientation or positional relationship referred to in the description of the orientation, such as upper, lower, front, rear, left, right, etc., is based on the orientation or positional relationship shown in the drawings only for the convenience of description of the present disclosure and simplification of the description, and does not indicate or imply that the device or element referred to must have a specific orientation, be constructed and operated in a specific orientation, and thus, should not be construed as limiting the present disclosure.

In the description of the present disclosure, if there are first and second descriptions for distinguishing technical features, they are not interpreted as indicating or implying relative importance or implicitly indicating the number of indicated technical features or implicitly indicating the precedence of the indicated technical features.

In the description of the present disclosure, unless otherwise specifically limited, terms such as set, installation, connection and so on should be understood in a broad sense, and those skilled in the art can reasonably determine the specific meanings of the above terms in the present disclosure by combining the specific contents of the technical schemes.

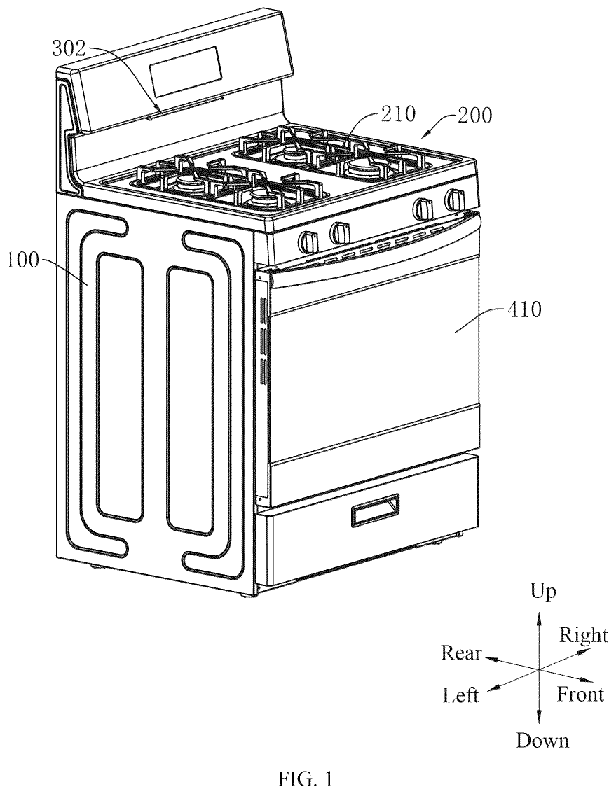

An integrated gas stove according to a non-limiting embodiment of the present disclosure will be described with reference to FIGS. 1 to 9.

As shown in FIGS. 1 to 4, the integrated gas stove according to the embodiment of the present disclosure includes a rack 100, a cooker assembly 200, an oven assembly, and a fume exhaust pipe 300. The cooker assembly 200 is disposed at an upper part of the rack 100, and the cooker assembly 200 includes at least one burner assembly 210. The oven assembly is arranged in the rack 100 and positioned below the cooker assembly 200. The oven assembly includes a case body 400 in the rack 100 and a combustion assembly 500 below the case body 400. An exhaust hole 402 is formed in an upper part of the case body 400. An heat conduction hole 401 is formed on a lower part of the case body 400. Hot air generated by combustion in the combustion assembly 500 is capable of entering the case body 400 through the heat conduction hole 401. A fume inlet 301 of the fume exhaust pipe 300 is connected to the exhaust hole 402, and a fume outlet 302 of the fume exhaust pipe 300 is arranged above the cooker assembly 200. The fume outlet 302 obliquely faces downwards the burner assembly 210, and a cross-sectional area of the fume exhaust pipe 300 tapers from the fume inlet 301 to the fume outlet 302.

When the integrated gas stove is used, the hot air generated by the combustion in the combustion assembly 500 enters the case body 400 through the heat conduction hole 401, so that food in the case body 400 is heated by the hot air. After that, formed oil fume enters the fume exhaust pipe 300 through the exhaust hole 402, and it is in turn conveyed above the cooker assembly 200 through the fume exhaust pipe 300. The exhaust hole 402 and the heat conduction hole 401 adopt an up and down layout structure, and air convection inside and outside the case body 400 can be formed by a chimney effect, so that the oil fume can be exhausted efficiently. The sectional area of the fume exhaust pipe 300 tapers from the fume inlet 301 to the fume outlet 302 to improve an eject velocity of the oil fume at the fume outlet 302. Since the fume outlet 302 obliquely faces downwards the burner assembly 210, the oil fume with certain velocity can efficiently eject to a corresponding position of the burner assembly 210, which makes it convenient for an external range hood to extract and discharge the oil fume.

Specifically, a position of the external range hood generally corresponds to that of the burner assembly 210. The oil fume is ejected to the corresponding position of the burner assembly 210, the oil fume of the oven then can be carried to a suction region of the external range hood, thereby realizing a purpose that the integrated gas stove without the range hood utilizes the external range hood to extract and discharge the oil fume produced in the oven, and achieving a better effect of extracting and discharging the oil fume as compared with the related art.

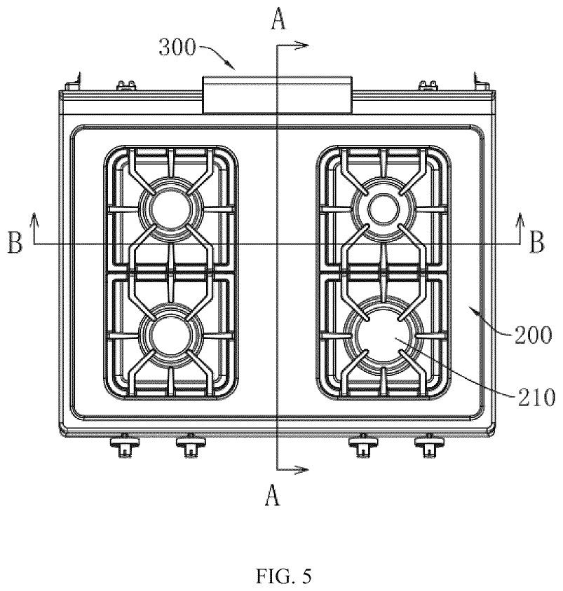

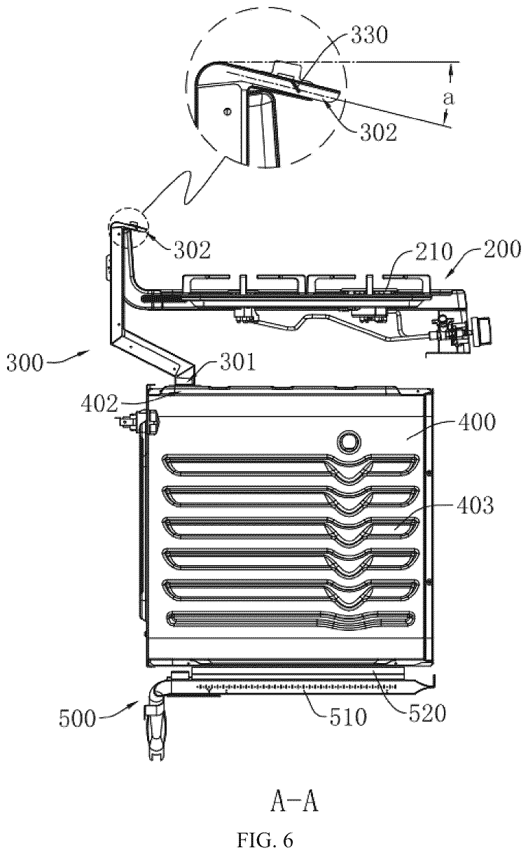

As shown in FIGS. 5 and 6, in some non-limiting embodiments of the present disclosure, the fume outlet 302 has a preset distance from an edge of a vertical projection area of the burner assembly 210 in a horizontal direction to prevent the fume outlet 302 from impeding a placement of a pot. In the above embodiment, a cross-sectional area of the fume exhaust pipe 300 tapers from the fume inlet 301 to the fume outlet 302, so that a eject velocity of the oil fume at the fume outlet 302 is increased, and the oil fume output through the fume outlet 302 can be efficiently ejected to the corresponding position of the burner assembly 210, which enables the external range hood to extract and discharge the oil fume.

Specifically, the distance between the fume outlet 302 and the edge of the vertical projection area of the burner assembly 210 in the horizontal direction is preset according to actual requirements, and the preset distance can be set to be 5 cm, 10 cm, 15 cm and so on according to sizes of different pots.

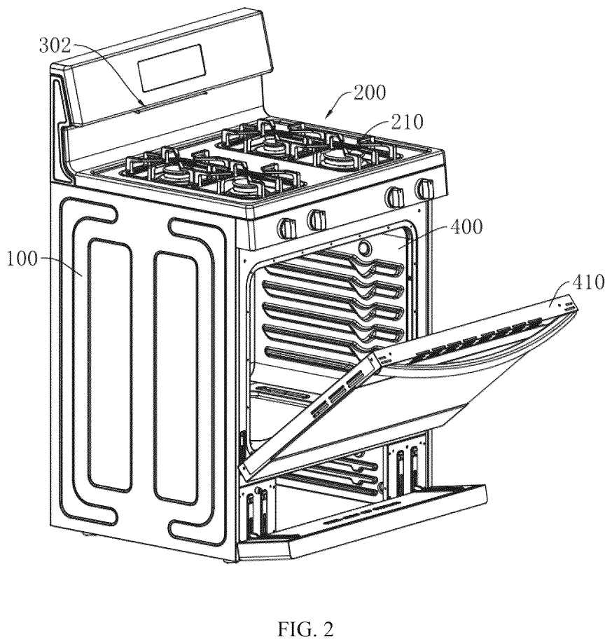

As shown in FIGS. 1 and 2, in some non-limiting embodiments of the present disclosure, a cabinet door 410 is disposed at a front side of the case body 400 to facilitate a user to take and place food.

Specifically, a lower portion of the cabinet door 410 may be rotatably coupled to a lower portion of the case body 400, so that the cabinet door 410 is capable of being outwardly turned to open the case body 400.

It can be understood that, in some non-limiting embodiments of the present disclosure, a side portion of the cabinet door 410 is rotatably connected with a side portion of the case body 400, and a locking mechanism is provided on another side of the cabinet door 410 and the case body 400. After the locking mechanism is unlocked, the cabinet door 410 is capable of being turned sideways to open the case body 400.

In some non-limiting embodiments of the present disclosure, the integrated gas stove further includes a gas supply assembly. The burner assembly 210 and the combustion assembly 500 are respectively connected to the gas supply assembly to meet a combustion requirement of the burner assembly 210 and the combustion assembly 500.

Specifically, the gas supply assembly may include one or more valve elements and pipe elements. The valve elements may be a proportional valve, a switch valve, a pressure relief valve, a pressure reduction valve and so on, and the gas supply assembly may adopt a natural gas, a petroleum gas and so on as a gas source or adopt other combustible gas as the gas source.

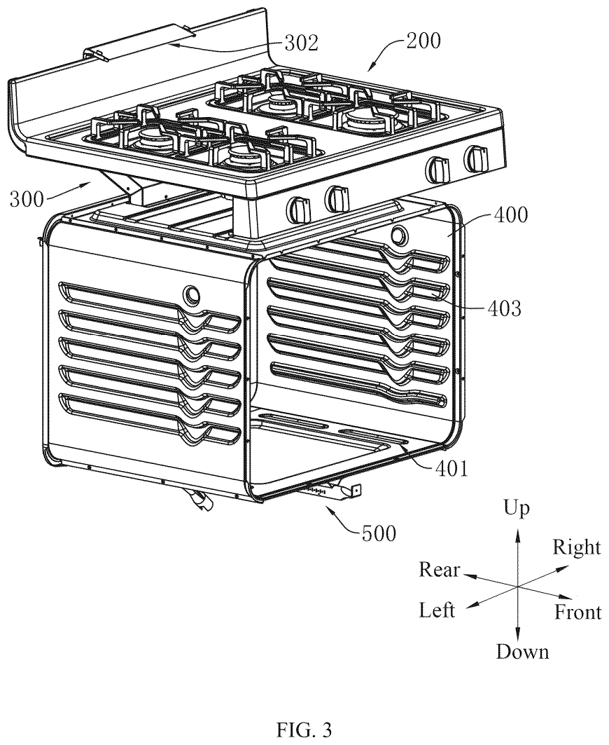

As shown in FIGS. 3 to 6, in some non-limiting embodiments of the present disclosure, the fume exhaust pipe 300 is provided at a rear of the rack 100, thereby facilitating a layout of the cooker assembly 200 and the oven assembly, and preventing the fume exhaust pipe 300 from impeding a normal arrangement of the cooker assembly 200 and the oven assembly or an operating space at the cooker assembly 200.

Specifically, the cooker assembly 200 and oven assembly adopt an up and down layout structure, and a front portion of the oven assembly is required to arrange a door body. A front of the cooker assembly 200 is required to enable a user to stand, and a certain operating space need be reserved at left and right sides of the cooker assembly 200 to enable the user to cook or remove a cookware. The fume exhaust pipe 300 is arranged at the rear of the rack 100 to avoided that the fume exhaust pipe 300 extending upward from the oven assembly impedes the normal arrangement of the cooker assembly 200 and the oven assembly or the operating space at the cooker assembly 200.

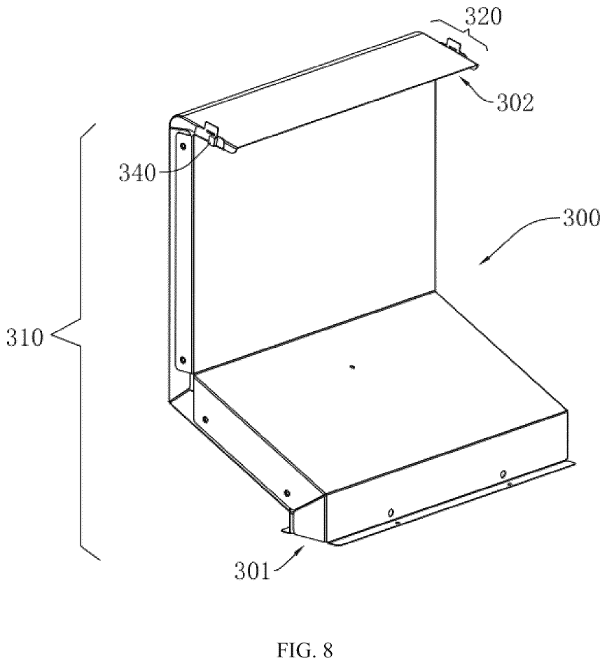

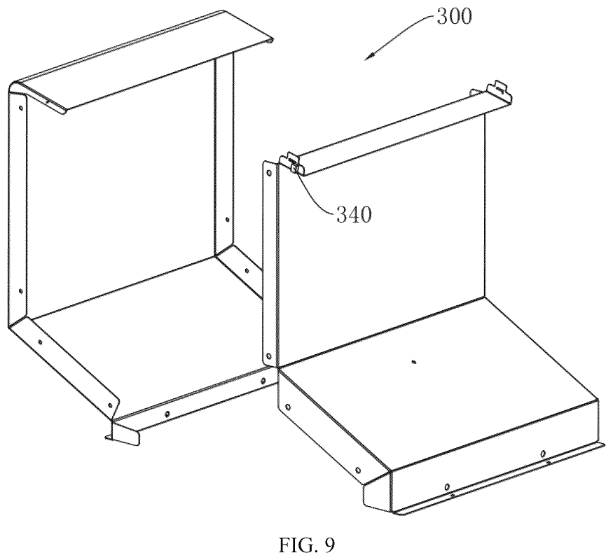

As shown in FIGS. 8 and 9, in some non-limiting embodiments of the present disclosure, the fume exhaust pipe 300 is formed by assembling two sheet metal parts, which are bent into corresponding shapes and assembled to form a fume exhaust channel with a preset width.

Specifically, a cross section of the fume exhaust pipe 300 is rectangular. The two sheet metal parts are respectively bent into a shape corresponding to a half of a structure with a rectangular cross section, and fixed by clamping, riveting, screwing and so on, in order to the fume exhaust pipe 300.

It will be appreciated that in some non-limiting embodiments of the present disclosure, the fume exhaust pipe 300 may also be formed by multiple sections of pipes assembled together.

As shown in FIG. 6, in some non-limiting embodiments of the present disclosure, the fume outlet 302 obliquely faces downwards the burner assembly 210. In other words, a descending structure is formed at an end of the fume exhaust pipe 300, so that the fume blows obliquely downwards the burner assembly 210, and occurrences of backflow of water vapors and oil fumes of the cooker assembly 200 to the case body 400 can be reduced.

As shown in FIG. 8, in some non-limiting embodiments of the present disclosure, the fume exhaust pipe 300 includes an ascending section 310 extending from bottom to top and an eject section 320 connecting the ascending section 310 and extending laterally. The fume inlet 301 is disposed at a lower end of the ascending section 310, and the fume outlet 302 is arranged at a top end of the eject section 320. The eject section 320 inclines obliquely downward, and has an included angle a between the eject section 320 and a cooker plane of the cooker assembly 200, so that the fume outlet 302 which outputs the oil fume obliquely downward is formed, and occurrences of backflow of water vapors and oil fumes of the cooker assembly 200 to the case body 400 can be reduced.

In some non-limiting embodiments of the present disclosure, the included angle a is 5° to 25°, which can satisfy the requirements of a downward ejection of the oil fume and a reduction of the backflow, and the included angle a is not too large to cause attenuation of a kinetic energy of the oil fume exhausting outwards.

Specifically, the included angle a can be set to be 5°, 10°, 15°, 20° and 25°, so that the requirements of a downward ejection of the oil fume and a reduction of the backflow can be met, and an influence on an exhaust velocity of the oil fume is small.

In some non-limiting embodiments of the present disclosure, a sum of the cross-sectional areas of all the heat conduction holes 401 is greater than the cross-sectional area of the exhaust hole 402 to improve an air intake efficiency in the case body 400, ensure that the oil fume can obtain sufficient ascending power under the chimney effect, and ensure that the oil fume outputted from the fume outlet 302 can have sufficient kinetic energy to be ejected to the burner assembly 210.

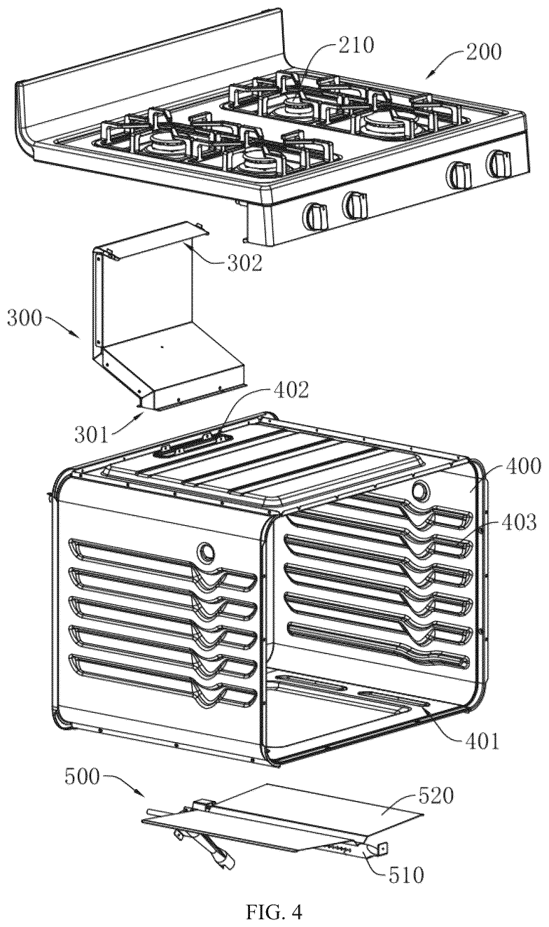

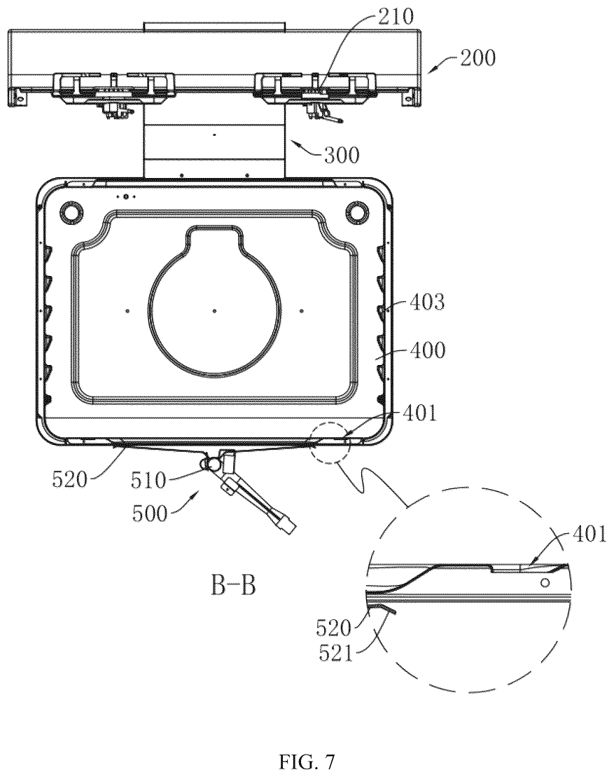

As shown in FIGS. 4 and 7, in some non-limiting embodiments of the present disclosure, the combustion assembly 500 includes a burner pipe 510 and a heat conducting plate 520. The burner pipe 510 has a long tubular structure. Two sides of the burner pipe 510 are respectively provided with a plurality of burner holes. The heat conducting plate 520 is a long plate member with a V-shaped cross section. The burner pipe 510 is located below the heat conducting plate 520 and is arranged corresponding to a tip of the V-shaped structure. The burner holes at two sides of the burner pipe 510 correspond to two wings of the V-shaped structure of the heat conducting plate 520. The heat conduction hole 401 of the case body 400 corresponds to ends of the two wings of the V-shaped structure of the heat conducting plate 520. After the gas ejected from the burner holes is ignited, a flame or heat flow can be directed to the heat conduction hole 401 through the two wings of the heat conducting plate 520 and enters the case body 400 through the heat conduction holes 401, thereby roasting the food in the case body 400.

In some non-limiting embodiments of the present disclosure, the exhaust hole 402 is an elongated hole, and a length direction of the burner pipe 510 and a length extending direction of the exhaust hole 402 are staggered with each other, thereby generating a certain turbulence effect on the hot air in the case body 400.

As shown in FIG. 4, in some non-limiting embodiments of the present disclosure, the exhaust hole 402 is an elongated hole, and the length direction of the burner pipe 510 is perpendicular to the length extending direction of the exhaust hole 402 to form a staggered structure, thereby generating the certain turbulence effect on the hot air in the case body 400, and heating food more evenly.

As shown in FIG. 7, in some non-limiting embodiments of the present disclosure, the ends of the two wings of the heat conducting plate 520 are respectively provided with a flow guiding portion 521 bent obliquely downwards. The flow guiding portion 521 can prevent hot air from directly entering the case body 400 through the heat conduction hole 401. The flow guiding portion 521 can direct the hot air to flow downward for a certain distance, and then the hot air is mixed with an ascending airflow (formed by the chimney effect), and finally the ascending airflow drives the hot air to enter the case body 400 through the heat conduction hole 401, thereby improving uniformity of hot air distribution.

Specifically, flow guiding portion 521 is short, so that it avoids causing the loss of heat energy. After the hot air mixes with the ascending airflow, the air in the ascending airflow can be heated, so that a temperature of the airflow entering the case body 400 through heat conduction hole 401 is uniform, and a problem of a temperature difference in the airflow is avoided.

In some non-limiting embodiments of the present disclosure, a ratio of a length of the flow guiding portion 521 to a distance from each of the ends of the two wings of the heat conducting plate 520 to a center of the heat conduction hole 401 is 1:5 to 1:20, so that the hot air and the ascending airflow can mix well.

Specifically, the ratio of the length of the flow guiding portion 521 to the distance from each of the ends of the two wings of the heat conducting plate 520 to the center of the heat conduction hole 401 is 1:12, so that a better mixing can be achieved. In some non-limiting embodiments, the ratio of the length of the flow guiding portion 521 to the distance from each of the ends of the two wings of the heat conducting plate 520 to the center of the heat conduction hole 401 may be 1:5, 1:10, 1:20, 1:25.

As shown in FIG. 7, in some non-limiting embodiments of the present disclosure, an outer hole wall of the heat conduction hole 401 is a slope structure inclined outwards from bottom to top, so that a part of the ascending airflow can be directed to blow towards a sidewall of the case body 400, and an amount of the hot air that directly blows toward the food is reduced. A part of the ascending airflow rises along the sidewall of the case body 400, thereby improving the uniformity of heat distribution in the case body 400 and the heating effect on the food.

As shown in FIG. 7, in some non-limiting embodiments of the present disclosure, the sidewall of the case body 400 has a convex portion 403 protruding toward the inside of the case body 400. A lower side of the convex portion 403 is a slope structure, so that the airflow rising along the sidewall of the case body 400 is directed to move toward the inside of the case body 400 by the slope structure to heat the food in the middle of the case body 400, so that the food is heated more uniformly.

In some non-limiting embodiments of the present disclosure, the heat conduction hole 401 and the exhaust holes 402 are both elongated holes, and a length extending direction of the heat conduction hole 401 and that of the exhaust hole 402 are staggered with each other, thereby generating the certain turbulence effect on the hot air in the case body 400.

As shown in FIG. 4, in some non-limiting embodiments of the present disclosure, the heat conduction hole 401 and the exhaust hole 402 are both elongated holes, and the extending direction of the heat conduction hole 401 is perpendicular to that of the exhaust hole 402 to form a staggered structure, thereby generating a certain turbulence effect on the hot air in the case body 400, and heating the food more uniformly.

It can be understood that, in some non-limiting embodiments of the present disclosure, the combustion assembly 500 may also be a gas burner uniformly distributed at a bottom of the case body 400 and corresponding to the heat conduction hole 401, which may also meet a requirement of the case body 400 for roasting food.

In some non-limiting embodiments of the present disclosure, a switch mechanism is disposed at the fume outlet 302. The switch mechanism is capable of controlling an opening degree of the fume outlet 302. An initial velocity V0 of the oil fume discharged through the fume outlet 302 can be controlled by controlling the opening degree of the fume outlet 302, so that the oil fume can be ejected to a set distance, and when the oil fume is ejected to a set position (the corresponding position of the burner assembly 210), a velocity of the oil fume is not too high.

Specifically, the switch mechanism includes a baffle plate 330 rotatably disposed on the fume exhaust pipe 300 near the fume outlet 302, and a rotation driving mechanism 340 disposed on a side wall of the fume exhaust pipe 300 and connected to the baffle plate 330. The rotation driving mechanism 340 drives the baffle plate 330 to rotate, thereby controlling the opening degree of the fume outlet 302.

In some non-limiting embodiments of the present disclosure, the rotation driving mechanism 340 is a steering engine, which can meet the requirement of precise control.

In some non-limiting embodiments, the rotation driving mechanism 340 may be a micro motor or the like.

It can be understood that, in some non-limiting embodiments of the present disclosure, the switch mechanism may adopt a flashboard type switch structure. A flashboard that can be driven to move up and down by a corresponding lifting drive mechanism is disposed at a position of the fume exhaust pipe 300 near the fume outlet 302, so that a height of the flashboard is controlled to adjusted the opening degree of the fume outlet 302.

In some non-limiting embodiments of the present disclosure, the case body 400 has a temperature detection module, which can detect a temperature T in the case body 400. The integrated gas stove further includes a control system, which is respectively connected to the temperature detection module and the switch mechanism. The control system can control an action of the switch mechanism according to the temperature T, and the opening degree of the fume outlet is in direct proportion to the temperature T. The higher the temperature T in the case body 400 is, the larger the opening degree of the fume outlet 302 is, thereby controlling an initial velocity of the oil fume at the fume outlet 302.

Specifically, in general, the higher the temperature T in the case body 400 is, the more the generated oil fume is, and the more obvious the chimney effect is, resulting in a higher rising velocity of the air. In other words, when the temperature T rises, the initial velocity of the oil fume at the fume outlet 302 is higher. The opening degree of the fume outlet 302 is increased to reduce the initial velocity of the oil fume at the fume outlet 302, so that the velocity of the oil fume is not too high when it is ejected to the setting position (the corresponding position of the burner assembly 210). If the velocity of the oil fume reaching the setting position is too high, the oil fume is easily caused to escape to other positions, and the effect of discharging the oil fume is affected.

In some non-limiting embodiments of the present disclosure, the opening degree of the fume outlet 302 is D, which is 0 to 100%. The sum of the cross-sectional areas of all the heat conduction holes is S1. The cross-sectional area of the exhaust hole is S2. The opening degree of the fume outlet is calculated by a formula of

$$D = \frac{S 1}{S 2} T K 1 ,$$

where K1 is a correction coefficient.

Specifically, the larger a ratio of the sum of the cross-sectional areas S1 of the heat conduction holes 401 to the cross-sectional areas S2 of the exhaust hole 402 is, the larger the air intake amount is. When the air intake amount becomes larger, the opening degree D has to be increased to slow down the initial velocity V0 of the oil fume at the fume outlet 302, so that a value of S1/S2 is also in proportion to the opening degree D. Therefore, the formula

$$D = \frac{S 1}{S 2} T K 1$$

is obtained, where K1 is the correction coefficient, which needs to be set according to an actual condition and experience. Factors influencing K1 include an external temperature, an air density, an air resistance, the included angle a and so on. In practice, when the integrated gas stove leaves the factory, an operator sets K1 according to climatic conditions of a sales area of the integrated gas stove, and inputs K1, S1 and S2 to the control system.

Based on the above formula, the control system detects the temperature T in the case body 400 through the temperature detection module, and determines the opening degree D of the fume outlet 302 according to the formula

$$D = \frac{S 1}{S 2} T K 1.$$

The control system controls the switch mechanism according to an actual value of the opening degree D, so that the initial velocity V0 of the oil fume at the fume outlet 302 reaches a set value.

In some non-limiting embodiments of the present disclosure, the fume outlet 302 faces a center of the cooker assembly 200, and the fume sent through the fume outlet 302 is blown to a center of the cooker assembly 200 at a central velocity V, which is greater than Om/s, so that the oil fume can be ejected to the center of the cooker assembly 200.

Specifically, the cooker assembly 200 includes four burner assemblies 210, and the center of the cooker assembly 200 is a center of the four burner assemblies 210.

In some non-limiting embodiments, the cooker assembly 200 may be provided with one or more burner assemblies 210 as desired, while the center of the cooker assembly 200 is the center of a spatial location of all burner assemblies 210.

In some non-limiting embodiments of the present disclosure, V is equal to or greater than 0.005 m/s and is equal to or less than 0.02 m/s. Therefore, the fume reaches the center of the cooker assembly 200 at a relatively slow velocity, and the fume is not easy to escape, and is relatively easy to be discharged by the external range hood.

In some non-limiting embodiments of the present disclosure, when the oven assembly is in operation, the initial velocity of the fume output at the fume outlet 302 is set to be V0, the opening degree of the fume outlet 302 is set to be D, which is 0 to 100%. The integrated gas stove further includes a control system, which is capable of controlling an action of the switch mechanism according to the central velocity V. The fume outlet 302 has a wind velocity detection unit capable of detecting the initial velocity V0. A distance from a central position of the fume outlet 302 to the center of the cooker assembly 200 is L. The wind velocity attenuation coefficient per unit distance of the fume in the air is A. The central velocity V is calculated by a formula of V=V0−L•A. The control system can calculate the central velocity V by detecting the initial velocity V0, and control the switch mechanism according to a numerical range of V to control the opening degree D, thereby increasing or decreasing the initial velocity V0.

Specifically, the wind velocity detection unit detects the initial velocity V0, and the control system can determine the central velocity V through the formula V=V0−L•A. The central velocity V is in direct proportion to the opening degree D. When the central velocity V is less than 0.005 m/s, the control system decreases the opening degree D to increase the initial velocity V0 of the fume output at the fume outlet 302, thereby increasing the central velocity V to be greater than or equal to 0.005 m/s. When the central velocity V is greater than 0.02 m/s, the control system increases the opening degree D to decrease the initial velocity V0 of the fume output at the fume outlet 302, thereby decreasing the central velocity V to be lower than or equal to 0.02 m/s, keeping the central velocity V between 0.005 m/s and 0.02 m/s, enabling the fume to reach the center of the cooker assembly 200 at a relatively gentle velocity. Therefore, the fume is not easy to escape, and is easier to be discharged by the external range hood.

Specifically, the wind velocity attenuation coefficient A is a conventional parameter. An operator sets the wind velocity attenuation coefficient according to the actual situation and experience of a sales area. Because a density of the oil fume is slightly larger than that of air, an attenuation velocity of the oil fume is larger than that of the air, and the oil fume generally attenuates at 0.4 m/s to 1 m/s per meter.

The application is not limited to the above embodiments, and those having ordinary skill in the art can make equivalent modifications or substitutions without departing from the essential of the application, and such equivalent modifications or substitutions are included in the scope of the application defined by the claims.

What is claimed is:

1. An integrated gas stove comprising:
a rack;
a cooker assembly, arranged at an upper part of the rack and comprising at least one burner assembly;
an oven assembly, arranged on the rack and located below the cooker assembly, comprising a case body arranged in the rack and a combustion assembly arranged below the case body, wherein an exhaust hole is arranged in an upper part of the case body, and a heat conduction hole is arranged on a lower part of the case body, so that hot air formed by combustion in the combustion assembly is capable of entering the case body through the heat conduction hole; and
a fume exhaust pipe, wherein a fume inlet of the fume exhaust pipe is connected to the exhaust hole, a fume outlet of the fume exhaust pipe arranged above the cooker assembly obliquely faces downwards the burner assembly, and a cross-sectional area of the fume exhaust pipe tapers from the fume inlet to the fume outlet.

2. The integrated gas stove of claim 1, wherein the fume exhaust pipe comprises an ascending section extending from bottom to top and a eject section connected with the ascending section and extending laterally, the fume inlet is arranged at a bottom end of the ascending section, the fume outlet is arranged at a top end of the eject section, the eject section inclines downwards, and a comprised angle a between the eject section and a cooker plane of the cooker assembly is 5° to 25°.

3. The integrated gas stove of claim 1, wherein a sum of cross-sectional areas of all the heat conduction holes is larger than a sectional area of the exhaust hole.

4. The integrated gas stove of claim 1, wherein the heat conduction hole and the exhaust hole are both elongated holes, and a length extending direction of the heat conduction hole and a length extending direction of the exhaust hole are perpendicular to each other.

5. The integrated gas stove of claim 1, wherein, a switch mechanism arranged at the fume outlet is capable of controlling an opening degree of the fume outlet.

6. The integrated gas stove of claim 5, wherein the case body comprises a temperature detection module capable of detecting a temperature T in the case body, the integrated gas stove further comprises a control system respectively connected to the temperature detection module and the switch mechanism, and the control system is capable of controlling an action of the switch mechanism according to the temperature T, so that the opening degree of the fume outlet is in direct proportion to the temperature T.

7. The integrated gas stove of claim 6, wherein the opening degree of the fume outlet D is in a range of 0 to 100%, and calculated by a formula of
$$D = \frac{S 1}{S 2} T K 1 ,$$
where S1 is a sum of the cross-sectional areas of all the heat conduction holes, S2 is a cross-sectional area of the exhaust hole, and K1 is a correction coefficient.

8. The integrated gas stove of claim 5, wherein the fume outlet faces a center of the cooker assembly, so that a central velocity of the oil fume which is discharged from the fume outlet and ejected to the center of the cooker assembly is V, and V is larger than 0 m/s.

9. The integrated gas stove of claim 8, wherein V is equal to or greater than 0.005 m/s and is equal to or less than 0.02 m/s.

10. The integrated gas stove of claim 9, wherein the fume outlet comprises a wind velocity detecting unit capable of detecting the initial velocity V0 during an operation of the oven assembly, and the integrated gas stove further comprises a control system capable of controlling an action of the switch mechanism according to the central velocity V, which is determined by the control system according to a formula V=V0−L•A, where L is a distance from a central position of the fume outlet to the center of the cooker assembly, and A is a wind velocity attenuation coefficient of a unit distance of the oil fume in air, and controlling the switch mechanism according to a numerical range of the central velocity V, thereby controlling the opening degree D of the fume outlet, which is in a range of 0 to 100%.
